(19) United States
(12) Patent Application Publication
(10) Pub. No.: US 2016/0291987 A1
(43) Pub. Date: Oct. 6, 2016

(54) PROGRAMMABLE CABLE AND PROGRAMMING METHOD THEREOF

(71) Applicant: VIA Technologies, Inc., New Taipei City (TW)

(72) Inventors: Yu-Lung Lin, New Taipei City (TW); Wei-Hang Lin, New Taipei City (TW)

(21) Appl. No.: 14/841,714

(22) Filed: Sep. 1, 2015

Related U.S. Application Data
(60) Provisional application No. 62/141,224, filed on Mar. 31, 2015.

(30) Foreign Application Priority Data
Jun. 26, 2015 (TW) 104120762

(51) Int. Cl. G06F 9/44; G06F 13/38; G06F 12/02

(52) U.S. Cl. CPC G06F 9/4411; G06F 12/0246; G06F 13/385; G06F 2212/7201

(57) ABSTRACT

A programmable cable and a programming method thereof are provided. The method includes: receiving a power signal and register setting data respectively through a first setting pin and a second setting pin from a downstream facing port; and accessing a register of a connector of the programmable cable according to the register setting data so as to write the register setting data into a non-volatile memory.

### CROSS-REFERENCE TO RELATED APPLICATION

This application claims the priority benefits of U.S. provisional application Ser. No. 62/141,224, filed on Mar. 31, 2015 and Taiwan application serial no. 104120762, filed on Jun. 26, 2015. The entirety of each of the above-mentioned patent applications is hereby incorporated by reference herein and made a part of this specification.

### BACKGROUND OF THE INVENTION

1. Field of the Invention

The invention relates to a cable, and more particularly, to a programmable cable and a programming method thereof.

2. Description of Related Art

With the blooming development of mobile electronic devices, a data processing speed of the mobile electronic devices also shows a significant growth. As the data processing speed of the mobile electronic devices improves, there are increasingly demands for the data transmission. Accordingly, technology for developing data transmission cables also advances rapidly. Other than satisfying the demands in improvements for transmission speed, each product vendor also needs to create the uniqueness of the products to achieve the market positioning for the products. Therefore, different data transmission cables may be adapted by different vendors or different products. As such, cable suppliers need to produce cables with particular specifications in response to different demands from the different product vendors. Consequently, it has become an important issue to be solved as how to easily and quickly produce a cable that satisfies different demands of the different product vendors.

### SUMMARY OF THE INVENTION

The invention is directed to a programmable cable and a programming method thereof, which are capable of easily and quickly producing a cable that satisfies different demands of the product vendors.

A programmable cable of the invention includes a connector, a chip and a cable. Herein, the connector has a first setting pin and a second setting pin, which are capable of receiving a power signal and register setting data respectively through a first setting pin and a second setting pin from a downstream facing port. The chip is disposed in the connector, and the chip includes a non-volatile memory and at least one register. The chip accesses the register according to the register setting data from the second setting pin so as to write the register setting data into a non-volatile memory. The register setting data is configured to set preset storing data of the register. The cable is connected to the downstream facing port through the connector.

A connector of a programmable cable of the invention includes a non-volatile memory and at least one register, and a programming method includes steps of: receiving a power signal and register setting data respectively through a first setting pin and a second setting pin of the connector from a downstream facing port; and accessing the register according to the register setting data from the second setting pin so as to write the register setting data into the non-volatile memory, wherein the register setting data is configured to set preset storing data of the register.

Based on the above, according to the embodiments of the invention, the power signal and the register setting data are respectively received through the first setting pin and the second setting pin from the downstream facing port, and the register in the connector is accessed according to the register setting data to write the register setting data into the non-volatile memory, so as to set the programmable cable. As a result, the cable suppliers are able to easily and quickly produce the cable that satisfies different demands of the different product vendors.

To make the above features and advantages of the present disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a programmable cable according to an embodiment of the invention.

FIG. 2 is a flowchart of a programming method of a programmable cable according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

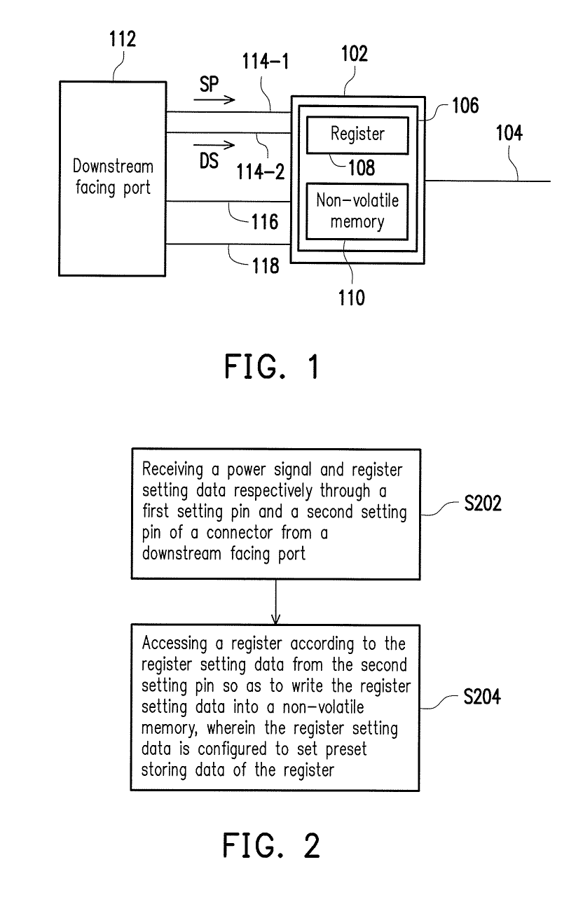

Referring to FIG. 1, FIG. 1 is a schematic diagram of a programmable cable according to an embodiment of the invention. The programmable cable includes a connector 102 and a cable 104. The connector 102 is disposed with a chip 106, and the chip 106 includes at least one register 108 and a non-volatile memory 110. The register 108 may be implemented by using Static Random Access Memories (SRAM) and the non-volatile memory 110 may be implemented by using One-Time Programming (OTP) memory, but the invention is not limited thereto. The connector 102 may be connected to a downstream facing port (DFP) 112. The downstream facing port 112 may be, for example, a host end. The cable may transmit data from the downstream facing port 112 to an upstream facing port (not illustrated) at another end of the cable 104 through the connector 102. The upstream facing port may be, for example, a device end.

The connector 102 has a setting pin 114-1 and a setting pin 114-2. In the present embodiment, the setting pin 114-1 and the setting pin 114-2 respectively receive a power signal SP and register setting data DS outputted from the downstream facing port 112. The chip 106 may access the register 108 according to the register setting data DS received by the setting pin 114-2 so as to write the register setting data DS into the non-volatile memory 110. Herein, the register setting data DS is configured to set preset storing data of the register 108 (i.e., initial data stored in the register 108 when the register 108 is power on). The preset storing data may be set based on demands of each product vendor. The preset storing data may be, for example, information regarding a product serial number, a specification, a product vendor and the like.

In the conventional technology where the cable suppliers are setting the preset storing data of the register for the cable, the preset storing data of the register is usually set by using an inter-integrated circuit (I2C) bus, a system management (SM) bus or a universal asynchronous receiver/transmitter (UART). However, all these setting methods are required to provide additional signal lines for the chip. Because the programmable cable of the present embodiment is capable of directly transmitting the power signal SP and the register setting data DS respectively through the setting pins 114_1 and 114_2 to the chip 106, the chip 106 may access the register 108 according to the register setting data DS so as to write the register setting data DS into the non-volatile memory 110. Accordingly, the preset storing data of the register 108 may be set without providing the additional signal lines for the chip 106. As a result, the cable suppliers are able to easily and quickly produce a cable that satisfies different demands of the product vendors.

For instance, a connection interface of the connector 102 may be a USB type-C interface, and the setting pins 114_1 and 114-2 may be configuration channel (CC) pins. More specifically, the setting pin 114_1 may be a configuration channel pin (CC1) and the setting pin 114_2 may be a configuration channel pin (CC2). Further, the register setting data DS may include, for example, a vendor-defined messaging (abbr. VDM). The vendor-defined messaging may include a message header, a configuration channel VDM header and a configuration channel vendor-defined data object (abbr. VDO). In the present embodiment, the message header, the configuration channel VDM header and the configuration channel VDO may be three fields of 16-bit, 32-bit and 32-bit, respectively. Herein, the message header includes information regarding a number of the fields in the VDM except for the field of the message header. For example, in the present embodiment, each of the configuration channel VDM header and the configuration channel VDO includes one field, so that the number of the fields indicated by the message header is two. More specifically, the message header may also include other information such as “the VDM is currently at which segment of the message”, “the message is sent by a source device or a sink device”, “power transmission specifications supported by a VDM transmitter”, “a VDM type” and so on.

The configuration channel VDM header may include information regarding whether the VDM belongs to a structured VDM or belongs to an unstructured VDM (which may be determined by states of a specific bit in the configuration channel VDM header, for example) and information indicating whether the VDM is used for Write, Read or Read Response (which may be determined by states of specific 15 bits in the configuration channel VDM header, for example). Further, the VDO may include, for example, information regarding addresses to which the VDM intends to perform actions of Write, Read or Read Response, information of the product serial number and information regarding Write, Read or Read Response. Further, in the present embodiment, the connector 102 may further include signal transmission pins 116 and 118 of USB 2.0 and USB 3.1 (i.e., the connector 102 may also include transmission interfaces of USB 2.0 and USB 3.1).

When writing the register setting data DS, the downstream facing port 112 may pull up the power signal SP outputted to the setting pin 114-1 (i.e., CC1) to a preset voltage (e.g., 6V, but the invention is not limited thereto) and output the VDM for writing the register setting data DS to the setting pin 114-2. After receiving the VDM through the setting pin 114-2 and confirming that the transmitted message is corrected, the chip 106 may access the register 108 according to the register setting data DS so as to write the register setting data DS into the non-volatile memory 110. Meanwhile, the chip 106 transmits a good cyclic redundancy check (GoodCRC) back to the downstream facing port 112 through the setting pin 114-2 so as to inform the downstream facing port 112 that the VDM for writing the register setting data DS is received. Further, when reading the register 108, the downstream facing port 112 may output the VDM for reading the register 108 to the setting pin 114-2 (i.e., CC2). After receiving the VDM through the setting pin 114-2 and confirming that the transmitted message is corrected, besides transmitting the good cyclic redundancy check (GoodCRC) back to the downstream facing port 112 through the setting pin 114-2, the chip 106 further transmits the VDM for Read Response back to the downstream facing port 112 so as to inform the downstream facing port 112 that the VDM for reading the register 108 is received, and then transmits contents that the downstream facing port 112 intends to read to the downstream facing port 112. After receiving the VDM for Read Response, the downstream facing port 112 also transmits the GoodCRC back to the chip 106 through the setting pin 114-2 so as to inform the chip 106 that the VDM for Read Response is received.

It should be noted that, although the foregoing embodiment is described by using an example in which the setting pin 114-1 transmits the power signal SP and the setting pin 114-2 transmits the register setting data DS, the connector 102 may be connected to the downstream facing port 112 through the USB type-C interface in upside-up or upside-down directions. In other words, the signals that the setting pin 114-1 and the setting pin 114-2 are responsible of transmitting may be exchanged according whether the connector 102 is connected in upside-up or upside-down directions. For example, assuming that the connector 102 is connected to the downstream facing port 112 in upside-up direction, the setting pin 114-1 is responsible of transmitting the power signal SP and the setting pin 114-2 is responsible of transmitting the register setting data DS. On the other hand, when the connector 102 is connected to the downstream facing port 112 in upside-down direction, the setting pin 114-1 is changed to transmit the register setting data DS and the setting pin 114-2 is changed to transmit the power signal SP.

As described above, by transmitting the power signal SP and the VDM for writing the register setting data DS into the non-volatile memory 110 through the configuration channel (CC) pins provided by the USB type-C, it is not required to use the conventional method in which the register must be set through the interfaces (such as the I2C bus, the SM bus or the universal asynchronous receiver/transmitter (UART)) while setting the preset storing data of the register for the cable. Accordingly, instead of setting the register before packaging the cable, the register may be set according to different demands of the product vendors after packaging of the programmable cable, such that the cable suppliers are able to easily and quickly produce the cable that satisfies different demands of the product vendors.

Referring to FIG. 2, FIG. 2 is a flowchart of a programming method of a programmable cable according to an embodiment of the invention. In view of the foregoing embodiment, it can be known that the programming method of the programmable cable includes the following steps. First of all, a power signal and register setting data are respectively received through a first setting pin and a second setting pin of a connector of the programmable cable from a downstream facing port (step S202). Herein, when the register setting data is received by the second setting pin from the downstream facing port, the first setting pin (for transmitting the power signal) is pulled up to a preset voltage. For example, a connection interface of the connector is a USB type-C interface, the first setting pin is a configuration channel pin (CC1), and the second setting pin is a configuration channel pin (CC2). Herein, the signals that the first setting pin and the second setting pin are responsible of transmitting are exchanged according to whether the USB type-C connector is connected in upside-up or upside-down directions, and the register setting data may include a vendor-defined messaging (VDM). Specifically, the vendor-defined messaging may include a message header, a configuration channel VDM header and a configuration channel vendor-defined data object (VDO). Moreover, in some embodiments, the connector further includes signal transmission pins of USB 2.0 and USB 3.1. Subsequently, the register is accessed according to the register setting data from the second setting pin so as to write the register setting data into a non-volatile memory, wherein the register setting data is configured to set preset storing data of the register (step S204). The preset storing data is initial data stored in the register when the register is power on.

In summary, according to the embodiments of the invention, the power signal and the register setting data are respectively received through the first setting pin and the second setting pin from the downstream facing port, and the register in the connector is accessed according to the register setting data to write the register setting data into the non-volatile memory, so as to set the programmable cable. As a result, the cable suppliers are able to easily and quickly produce the cable that satisfies different demands of the different product vendors.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A programmable cable, comprising:
a connector, having a first setting pin and a second setting pin, receiving a power signal and register setting data respectively through a first setting pin and a second setting pin from a downstream facing port;
a chip, disposed in the connector, and the chip comprising:
a non-volatile memory;
at least one register, wherein the chip accesses the at least one register according to the register setting data from the second setting pin so as to write the register setting data into the non-volatile memory, wherein the register setting data is configured to set preset storing data of the at least one register; and
a cable, connected to the downstream facing port through the connector.

2. The programmable cable of claim 1, wherein an connecting interface of the connector is a USB type-C interface, the first setting pin and the second setting pin are configuration channel pins, and the register setting data comprises a vendor-defined messaging.

3. The programmable cable of claim 2, wherein the vendor-defined messaging comprises a message header, a configuration channel vendor-defined messaging header and a configuration channel vendor-defined data object.

4. The programmable cable of claim 2, wherein the power signal is pulled up to a preset voltage when the register setting data is received by the second setting pin.

5. The programmable cable of claim 2, wherein the connector further comprises signal transmission pins of USB 2.0 and USB 3.1.

6. A programming method of a programmable cable, wherein a connector of the programmable cable comprises a non-volatile memory and at least one register, and the programming method comprises:
receiving a power signal and register setting data respectively through a first setting pin and a second setting pin of the connector from a downstream facing port; and
accessing the at least one register according to the register setting data from the second setting pin so as to write the register setting data into the non-volatile memory, wherein the register setting data is configured to set preset storing data of the at least one register.

7. The programming method of the programmable cable of claim 6, wherein an connecting interface of the connector is a USB type-C interface, the first setting pin and the second setting pin are configuration channel pins, and the register setting data comprises a vendor-defined messaging.

8. The programming method of the programmable cable of claim 6, wherein the vendor-defined messaging comprises a message header, a configuration channel vendor-defined messaging header and a configuration channel vendor-defined data object.

9. The programming method of the programmable cable of claim 6, wherein the power signal is pulled up to a preset voltage when the register setting data is received by the second setting pin from the downstream facing port.

10. The programming method of the programmable cable of claim 6, wherein the connector further comprises signal transmission pins of USB 2.0 and USB 3.1.
